(19) United States
(12) Patent Application Publication
(10) Pub. No.: US 2024/0429539 A1
(43) Pub. Date: Dec. 26, 2024

(54) BATTERY PACK

(71) Applicant: Prime Planet Energy & Solutions, Inc., Tokyo (JP)

(72) Inventor: Shinobu TERAUCHI, Kasai-shi (JP)

(21) Appl. No.: 18/733,848

(22) Filed: Jun. 5, 2024

(30) Foreign Application Priority Data
Jun. 26, 2023 (JP) 2023-104399

(51) Int. Cl. H01M 50/276; H01M 50/209; H01M 50/264; H01M 50/317

(52) U.S. Cl. CPC H01M 50/276; H01M 50/209; H01M 50/264; H01M 50/317

(57) ABSTRACT

A battery pack includes: a cover that is attached to a case main body and that forms a space accommodating a plurality of battery cells; a plate member disposed between the plurality of battery cells and the cover; and a gasket sandwiched by the case main body and the cover. The plurality of battery cells are disposed in a frame to form a cell assembly, the frame having a rectangular shape in which a second direction corresponds to a long-side direction and a third direction corresponds to a short-side direction when viewed in a first direction orthogonal to a top surface of an exterior package facing the plate member. The plate member has an inclined portion, the inclined portion being inclined such that a distance between the top surface and the inclined portion is decreased in a direction toward an end portion of the cell assembly in the third direction.

### CROSS REFERENCE TO RELATED APPLICATIONS

This nonprovisional application is based on Japanese Patent Application No. 2023-104399 filed on Jun. 26, 2023 with the Japan Patent Office, the entire contents of which are hereby incorporated by reference.

### BACKGROUND OF THE INVENTION

### Field of the Invention

The present invention relates to a battery pack.

### Description of the Background Art

For example, WO 2020/189590 discloses a battery pack including: a secondary battery; a housing that accommodates the secondary battery; and a plate-shaped reinforcing portion that extends from one end to the other end of the housing in a long-side direction thereof and that is disposed in a height direction of the secondary battery so as to reinforce the housing.

Further, Japanese National Patent Publication No. 2021-535556 discloses a battery pack including: a cell; a first panel and a second panel respectively connected to an upper surface and a lower surface of the cell; and a heat conduction plate provided between the cell and the first panel.

### SUMMARY OF THE INVENTION

In the above-described battery pack disclosed in WO 2020/189590, the housing (case) that accommodates the secondary battery is constituted of: a main body portion having a rectangular box shape, the main body portion being opened at its upper portion; and a cover that covers the opening of the main body portion. In such a battery pack, there is such a concern that when high-pressure gas is jetted from the battery cell in response to occurrence of a battery abnormality, the gas is leaked from between the main body portion and the cover. Further, there is such a concern that the gas jetted from the battery cell may hit the cover to damage the cover.

Therefore, it is an object of the present invention to solve the above-described problem and to provide a battery pack to more securely prevent leakage of gas and damage of a cover.

[1] A battery pack comprising: a plurality of battery cells; a case main body provided with an opening; a cover that is attached to the case main body so as to close the opening and that forms, together with the case main body, a space for accommodating the plurality of battery cells; a plate member disposed between each of the plurality of battery cells and the cover in the space, the plate member being composed of a metal or ceramic; and a gasket sandwiched by the case main body and the cover, the gasket being composed of a metal or ceramic, wherein each of the battery cells has an exterior package that includes a top surface facing the plate member and that accommodates an electrode assembly and an electrolyte solution, and a gas-release valve that releases gas from inside of the exterior package to the space through the top surface when pressure in the exterior package becomes more than or equal to a predetermined value, the plurality of battery cells are disposed in a frame to form a cell assembly, the frame having a rectangular shape in which a second direction corresponds to a long-side direction of the frame and a third direction orthogonal to the second direction corresponds to a short-side direction of the frame when viewed in a first direction orthogonal to the top surface, and the plate member has an inclined portion, the inclined portion being inclined such that a distance between the top surface and the inclined portion in the first direction is decreased in a direction toward an end portion of the cell assembly in the third direction.

According to the battery pack thus configured, leakage of the gas from between the case main body and the cover can be more securely prevented by the gasket composed of a metal or ceramic. Further, the gas generated from the battery cell can be received by the plate member composed of a metal or ceramic, thereby preventing the cover from being damaged. In this case, the gas received by the plate member is guided by the inclined portion toward the end portion of the cell assembly in the third direction. Since the length of the cell assembly in the third direction is smaller than the length of the cell assembly in the second direction, the gas can be quickly evacuated from between the top surface and the cover, thereby preventing damage of the cover more securely.

[2] The battery pack according to [1], wherein the battery cell has a prismatic shape, the plurality of battery cells are stacked in one row in the second direction, and the distance between the top surface and the inclined portion in the first direction is decreased in a direction away from the gas-release valve in the third direction.

According to the battery pack thus configured, the gas received from the gas-release valve by the plate member can be more efficiently guided toward the end portion of the cell assembly in the third direction by the inclined portion.

[3] The battery pack according to [1] or [2], further comprising a duct that is provided to face the cell assembly in the third direction, that forms a gas flow path communicating with the space, and that discharges the gas from the space.

According to the battery pack thus configured, since the gas evacuated from between the top surface and the cover is discharged from the space through the duct, the cover can be more securely prevented from being damaged.

[4] The battery pack according to any one of [1] to [3], wherein the plate member and the gasket are integrally formed from a plate material composed of a metal or ceramic.

According to the battery pack thus configured, the leakage of the gas and the damage of the cover can be prevented while simplifying the configuration of the battery pack.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a battery pack according to a first embodiment of the present invention.

FIG. 2 is an exploded assembly diagram showing the battery pack in FIG. 1.

FIG. 3 is a perspective view showing a battery cell.

FIG. 4 is a cross sectional view schematically showing the battery pack when viewed in a direction of arrow along a line IV-IV in FIG. 1.

FIG. 5 is a cross sectional view showing a first modification of the battery pack in FIG. 4.

FIG. 6 is a cross sectional view showing a second modification of the battery pack in FIG. 4.

FIG. 7 is a cross sectional view showing a third modification of the battery pack in FIG. 4.

FIG. 8 is a cross sectional view showing a battery pack according to a second embodiment of the present invention.

FIG. 9 is a top view showing a cell assembly included in the battery pack in FIG. 8.

FIG. 10 is a cross sectional view showing a modification of the battery pack in FIG. 8.

FIG. 11 is a top view showing a cell assembly included in the battery pack in FIG. 10.

### DESCRIPTION OF THE PREFERRED EMBODIMENTS

Embodiments of the present invention will be described with reference to figures. It should be noted that in the figures referred to below, the same or corresponding members are denoted by the same reference characters.

### First Embodiment

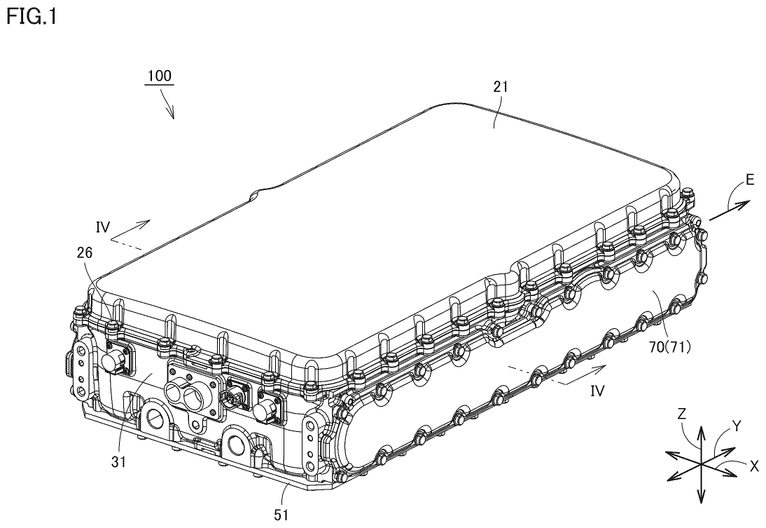

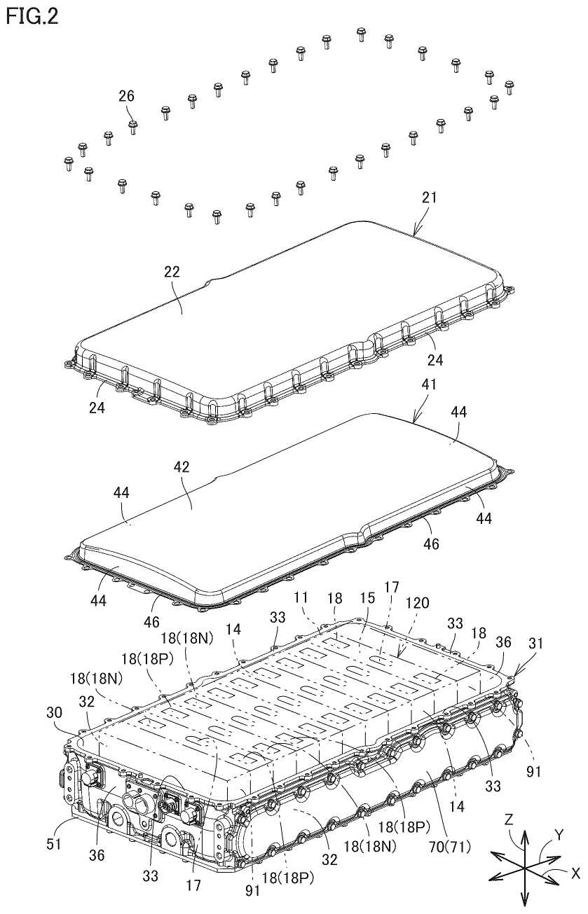

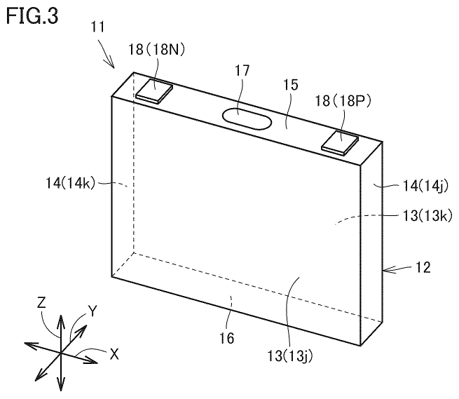

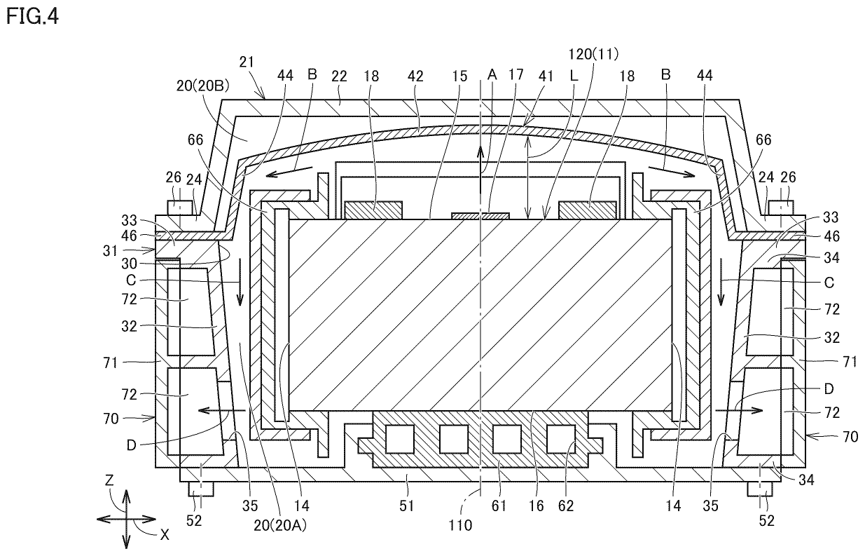

FIG. 1 is a perspective view showing a battery pack according to a first embodiment of the present invention. FIG. 2 is an exploded assembly diagram showing the battery pack in FIG. 1. FIG. 3 is a perspective view showing a battery cell. FIG. 4 is a cross sectional view schematically showing the battery pack when viewed in a direction of arrow along a line IV-IV in FIG. 1.

Referring to FIGS. 1 to 4, a battery pack 100 is used as a power supply for driving a vehicle such as a hybrid electric vehicle (HEV), a plug-in hybrid electric vehicle (PHEV), or a battery electric vehicle (BEV).

In the present specification, for convenience of explanation of a structure of battery pack 100, a “Y axis” represents an axis extending in a stacking direction of a plurality of below-described battery cells 11 and in a horizontal direction, an “X axis” represents an axis extending in a direction orthogonal to the Y axis and in the horizontal direction, and a “Z axis” represents an axis extending in an upward/downward direction. As shown in FIG. 4, battery pack 100 basically has a structure symmetrical with respect to an imaginary plane 110 parallel to the Y-Z axes plane.

Battery pack 100 has a plurality of battery cells 11. The plurality of battery cells 11 are stacked in the Y axis direction. The plurality of battery cells 11 are stacked in one row in the Y axis direction. Each of battery cells 11 is constituted of a lithium ion battery. Battery cell 11 has a prismatic shape and has a thin plate shape in the form of a rectangular parallelepiped. The plurality of battery cells 11 are stacked such that the Y axis direction corresponds to the thickness direction of each battery cell 11.

Each of battery cells 11 has an exterior package 12. Exterior package 12 is constituted of a housing having a rectangular parallelepiped shape, and forms the external appearance of battery cell 11. An electrode assembly and an electrolyte solution are accommodated in exterior package 12.

Exterior package 12 has a pair of first side surfaces 14 (14j, 14k), a pair of second side surfaces 13 (13j, 13k), a top surface 15, and a bottom surface 16.

First side surfaces 14 are each constituted of a flat surface orthogonal to the X axis. First side surfaces 14 are each parallel to the Y axis direction, which is the stacking direction of battery cells 11. First side surface 14j and first side surface 14k are oriented oppositely in the X axis direction. Second side surfaces 13 are each constituted of a flat surface orthogonal to the Y axis. Each of second side surfaces 13 has the largest area among those of the plurality of side surfaces of exterior package 12. Second side surface 13j and second side surface 13k are oriented oppositely in the Y axis direction. Each of top surface 15 and bottom surface 16 is constituted of a flat surface orthogonal to the Z axis. Top surface 15 is oriented upward. Bottom surface 16 is oriented downward.

Battery cell 11 further has a gas-release valve 17. Gas-release valve 17 is provided in top surface 15. Gas-release valve 17 is provided at the central position of top surface 15 in the X axis direction. When the pressure in exterior package 12 becomes equal to or more than a predetermined value, gas-release valve 17 releases the gas from inside of exterior package 12 to outside (space 20 described later) of exterior package 12 through top surface 15.

Battery cell 11 further has electrode terminals 18 including a pair of a positive electrode terminal 18P and a negative electrode terminal 18N. Each of electrode terminals 18 is provided on top surface 15. Positive electrode terminal 18P and negative electrode terminal 18N are provided to be separated from each other in the X axis direction. Positive electrode terminal 18P and negative electrode terminal 18N are provided on both sides beside gas-release valve 17 in the X axis direction.

The plurality of battery cells 11 are stacked such that second side surfaces 13j of battery cells 11, 11 adjacent to each other in the Y axis direction face each other and second side surfaces 13k of battery cells 11, 11 adjacent to each other in the Y axis direction face each other. Thus, positive electrode terminals 18P and negative electrode terminals 18N are alternately arranged in the Y axis direction in which the plurality of battery cells 11 are stacked. Between battery cells 11, 11 adjacent to each other in the Y axis direction, positive electrode terminal 18P and negative electrode terminal 18N arranged side by side in the Y axis direction are connected to each other by a bus bar (not shown). The plurality of battery cells 11 are electrically connected to one another in series.

As shown in FIG. 2, the plurality of battery cells 11 stacked in the Y axis direction form a cell assembly 120. Cell assembly 120 has a rectangular parallelepiped shape. The length of cell assembly 120 in the Y axis direction is larger than the length of cell assembly 120 in the Z axis direction and is larger than the length of cell assembly 120 in the X axis direction. The plurality of battery cells 11 are disposed in a frame to form cell assembly 120, the frame having a rectangular shape in which the Y axis direction corresponds to the long-side direction of the frame and the X axis direction orthogonal to the Y axis direction corresponds to the short-side direction of the frame when viewed in a plan view in the Z axis direction. Here, the frame having a rectangular shape is a line of minimum imaginary frame in which the plurality of battery cells 11 can be disposed.

Battery pack 100 further has a pair of end plates 91 and a pair of binding bars 66 (not shown in FIG. 2 and see FIG. 4). The pair of end plates 91 are respectively disposed at both ends of cell assembly 120 (the plurality of battery cells 11) in the Y axis direction. The pair of binding bars 66 are disposed at both ends of cell assembly 120 in the X axis direction. Each of binding bars 66 extends in the Y axis direction and is connected to the pair of end plates 91 at both ends thereof. The plurality of battery cells 11 are collectively held by the pair of end plates 91 and the pair of binding bars 66.

Battery pack 100 further has a case main body 31 and a cover 21. Each of case main body 31 and cover 21 is composed of a metal. Each of case main body 31 and cover 21 is composed of aluminum, for example. Case main body 31 is provided with an opening 30. Opening 30 is opened upward. Cover 21 is attached to case main body 31 so as to close opening 30. Cover 21 forms, together with case main body 31, a space 20 for accommodating the plurality of battery cells 11.

Case main body 31 has a bottom portion 51, a pair of first side portions 32, and a pair of second side portions 36. Bottom portion 51 has a wall shape in which bottom portion 51 is disposed along the X-Y axes plane with the Z axis direction corresponding to its thickness direction. Bottom portion 51 has a rectangular shape when viewed in a plan view in the Z axis direction. Cell assembly 120 is placed on bottom portion 51. A cooling plate 61 is interposed between bottom portion 51 and cell assembly 120. Cooling plate 61 is provided with a coolant path 62 extending in the Y axis direction.

The pair of first side portions 32 and the pair of second side portions 36 rise from the peripheral edge of bottom portion 51. The pair of first side portions 32 face each other in the X axis direction with space 20 being interposed therebetween. Each of first side portions 32 has a wall shape in which first side portion 32 is disposed along the Y-Z axes plane with the X axis direction corresponding to its thickness direction. The pair of second side portions 36 face each other in the Y axis direction with space 20 being interposed therebetween. Each of second side portions 36 has a wall shape in which second side portion 36 is disposed along the X-Z axes plane with the Y axis direction corresponding to its thickness direction.

Bottom portion 51 is fastened to the pair of first side portions 32 and the pair of second side portions 36 using a plurality of bolts 52. It is not limited to such a configuration, and bottom portion 51, the pair of first side portions 32, and the pair of second side portions 36 may be integrally formed from a metal.

Space 20 is formed at a position located above bottom portion 51 and surrounded by the pair of first side portions 32 and the pair of second side portions 36. Opening 30 is defined by the upper end portions of the pair of first side portions 32 and the pair of second side portions 36. Space 20 is opened to a space outside case main body 31 through opening 30.

Case main body 31 further has a first flange portion 33. First flange portion 33 extends in the form of a flange from the upper end portions of the pair of first side portions 32 and the pair of second side portions 36 in plane directions of the X-Y axes plane. First flange portion 33 is provided in the form of a frame along the upper end portions of the pair of first side portions 32 and the pair of second side portions 36.

Cover 21 has a cover main body portion 22 and a second flange portion 24. Cover main body portion 22 constitutes a main portion of cover 21, and closes opening 30. Cover main body portion 22 has a receiving pan shape so as to be opened downward with the Z axis direction corresponding to its depth direction. Second flange portion 24 extends in the form of a flange from the lower end portion of cover main body portion 22 in the plane directions of the X-Y axes plane. Second flange portion 24 is provided in the form of a frame along the lower end portion of cover main body portion 22. Second flange portion 24 overlaps with first flange portion 33 in the Z axis direction. Cover 21 is attached to case main body 31 by fastening first flange portion 33 and second flange portion 24 to each other using a plurality of bolts 26.

Battery pack 100 further has a plate member 41 and a gasket 46. Each of plate member 41 and gasket 46 is composed of a material having heat resistance to such an extent that the material is not deformed even when exposed to high-temperature gas or flame generated from battery cell 11, and is preferably composed of a metal or ceramic. For example, each of plate member 41 and gasket 46 is composed of a metal such as carbon steel, stainless steel, copper, aluminum, or titanium, or is composed of a ceramic such as alumina, zirconia, or silica. Each of plate member 41 and gasket 46 may be formed by coating a surface of each of the materials with a resin material. The thickness of each of plate member 41 and gasket 46 is smaller than the thickness of cover 21.

In the present embodiment, plate member 41 and gasket 46 are integrally formed from a plate material composed of a metal or ceramic. With such a configuration, the number of components of battery pack 100 can be reduced or the number of steps of assembling battery pack 100 can be reduced.

Plate member 41 is provided in space 20. Plate member 41 is disposed between each of the plurality of battery cells 11 (cell assembly 120) and cover 21 in space 20. Top surface 15 of battery cell 11 faces plate member 41 in the Z axis direction. Gasket 46 is sandwiched by case main body 31 and cover 21. Gasket 46 is interposed between first flange portion 33 and second flange portion 24. Gasket 46 receives fastening force by the plurality of bolts 26 between first flange portion 33 and second flange portion 24.

Plate member 41 has an inclined portion 42. Inclined portion 42 faces top surfaces 15 in the Z axis direction. Inclined portion 42 faces gas-release valves 17 in the Z axis direction. Inclined portion 42 faces electrode terminals 18 (positive electrode terminals 18P and negative electrode terminals 18N) in the Z axis direction. Inclined portion 42 is provided above cell assembly 120 (battery cells 11).

The length of inclined portion 42 in the X axis direction is larger than the length of cell assembly 120 (battery cells 11) in the X axis direction. The length of inclined portion 42 in the Y axis direction is larger than the length of cell assembly 120 in the Y axis direction. When viewed in a plan view in the Z axis direction, inclined portion 42 has a rectangular shape in which the Y axis direction corresponds to its long-side direction and the X axis direction corresponds to its short-side direction. The range of cell assembly 120 when viewed in a plan view in the Z axis direction is included in the range of inclined portion 42 when viewed in a plan view in the Z axis direction.

Inclined portion 42 is inclined such that a distance L between top surface 15 and inclined portion 42 in the Z axis direction is decreased in a direction toward the end portion of cell assembly 120 in the X axis direction in the cross section taken along the X-Z axes plane as shown in FIG. 4. Inclined portion 42 is inclined such that distance L between top surface 15 and inclined portion 42 in the Z axis direction is decreased in a direction toward each of both the end portions of cell assembly 120 in the X axis direction. Inclined portion 42 is inclined such that distance L between top surface 15 and inclined portion 42 in the Z axis direction is smaller at the end portion of cell assembly 120 in the X axis direction than at the central portion of cell assembly 120 in the X axis direction. Inclined portion 42 is inclined such that distance L between top surface 15 and inclined portion 42 in the Z axis direction is decreased in a direction from the central portion toward the end portion of cell assembly 120 in the X axis direction. Inclined portion 42 is inclined with respect to each of the X axis direction and the Z axis direction.

Distance L between top surface 15 and inclined portion 42 in the Z axis direction is decreased in a direction away from gas-release valve 17 in the X axis direction. Distance L between top surface 15 and inclined portion 42 in the Z axis direction is maximum at a position on imaginary plane 110, and is decreased in a direction away from imaginary plane 110 in the X axis direction. Distance L between top surface 15 and inclined portion 42 in the Z axis direction is unchanged regardless of a position in the Y axis direction.

In the cross sectional view of battery pack 100 taken along the X-Z axes plane in FIG. 4, inclined portion 42 has a cross section with a curved shape. Inclined portion 42 may have a cross section with a shape of arc having an unchanged curvature.

Plate member 41 further has a base portion 44. Base portion 44 extends from the peripheral edge of inclined portion 42 in a direction toward bottom portion 51 in the Z axis direction. Base portion 44 forms, together with inclined portion 42, a receiving pan shape so as to be opened downward with the Z axis direction corresponding to its depth direction.

Gasket 46 is provided in the peripheral edge of base portion 44. Gasket 46 is provided along the peripheral edge of base portion 44 when viewed in a plan view in the Z axis direction. Gasket 46 extends in the form of a flange from the lower end portion of base portion 44 in the plane directions of the X-Y axes plane. Gasket 46 is provided in the form of a frame along the lower end portion of base portion 44.

Space 20 is partitioned into a space 20A and a space 20B by plate member 41 and gasket 46. Space 20B is surrounded by plate member 41, gasket 46, and cover 21. Space 20A is surrounded by plate member 41, gasket 46, and case main body 31. The plurality of battery cells 11 are accommodated in space 20A.

Battery pack 100 further has a duct 70. Duct 70 is provided to face cell assembly 120 in the X axis direction. Duct 70 is provided to face first side surface 14 of battery cell 11. Duct 70 forms a gas flow path 72. Gas flow path 72 communicates with space 20. Duct 70 discharges, from space 20, gas released from gas-release valve 17.

Case main body 31 further includes a rib portion 34. Rib portion 34 protrudes from first side portion 32 in the X axis direction, and extends in the form of a rib along the peripheral edge of first side portion 32. Duct 70 has a pair of duct covers 71. The pair of duct covers 71 are attached to the pair of first side portions 32, respectively. Each of duct covers 71 is attached to first side portion 32 so as to come into abutment with rib portion 34 in the X axis direction.

Duct cover 71 forms a gas flow path 72 together with first side portion 32. A gas flow hole 35 is provided in first side portion 32. Gas flow hole 35 is constituted of a hole extending through first side portion 32, and communicates space 20 (20A) with gas flow path 72. Gas flow path 72 extends in the Y axis direction and is opened at one end portion thereof.

It is assumed that combustible gas is generated inside exterior package 12 in response to occurrence of a battery abnormality such as an internal short circuit in battery cell 11. The gas is discharged, through gas-release valve 17, into space 20 (20A) between top surface 15 and cover 21 (gas flow indicated by an arrow A in FIG. 4). The gas hits plate member 41, flows from the central portion of space 20 (20A) toward both end portions thereof in the X axis direction, and further flows downward through a clearance between cell assembly 120 and each first side portion 32 (gas flow indicated by each of arrows B and C in FIG. 4). The gas is discharged from space 20 (20A) to gas flow path 72 through gas flow hole 35 (gas flow indicated by an arrow D in FIG. 4). The gas flows through gas flow path 72 in the Y axis direction and is discharged to the outside of duct 70 (gas flow indicated by an arrow E in FIG. 1).

In response to an increase in capacity of the battery in recent years, an amount of gas generated in battery cell 11 is increased. For this reason, high-pressure gas may be jetted from battery cell 11, or the gas may be increased in pressure to have a high temperature to result in spontaneous ignition. In preparation for such a case, plate member 41 and gasket 46 are provided in battery pack 100 according to the present embodiment.

First, by gasket 46 sandwiched by case main body 31 and cover 21 and composed of a metal or ceramic, the gas can be prevented from being leaked from a portion other than the gas-discharge path.

Next, in space 20, plate member 41 disposed between each of the plurality of battery cells 11 (cell assembly 120) and cover 21 receives the high-pressure gas jetted from battery cell 11 or a shock wave caused by the spontaneous ignition, thereby preventing cover 21 from being damaged. In addition, plate member 41 also has a heat shielding function to prevent cover 21 from being exposed to the high-temperature gas. In such a case, the gas received by plate member 41 is guided by inclined portion 42 toward each of the both end portions of cell assembly 120 in the X axis direction (in a direction away from gas-release valve 17). Since the length of cell assembly 120 in the X axis direction is smaller than the length of cell assembly 120 in the Y axis direction, the gas can be quickly evacuated from between top surface 15 and cover 21 and can be discharged from space 20 through duct 70. Thus, cover 21 can be more securely prevented from being damaged.

FIGS. 5 to 7 are cross sectional views showing modifications of the battery pack in FIG. 4. Referring to FIG. 5, in the present modification, in the cross sectional view of battery pack 100 taken along the X-Z axes plane, inclined portion 42 has a cross section with a shape of straight line. Inclined portion 42 extends in the form of a straight line between imaginary plane 110 and base portion 44 in the X-Z axes plane with inclined portion 42 having a certain inclination.

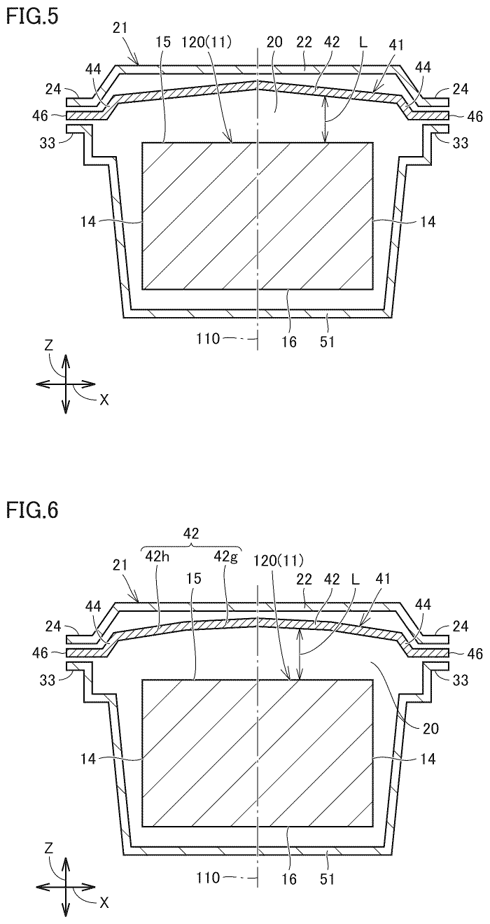

Referring to FIG. 6, in the present modification, in the cross sectional view of battery pack 100 taken along the X-Z axes plane, inclined portion 42 has a cross section with a shape of straight line. Inclined portion 42 has a first portion 42g and a second portion 42h. First portion 42g extends between imaginary plane 110 and second portion 42h in the X-Z axes plane with first portion 42g having a certain inclination. Second portion 42h extends between first portion 42g and base portion 44 in the X-Z axes plane with second portion 42h having a certain inclination different from that of first portion 42g.

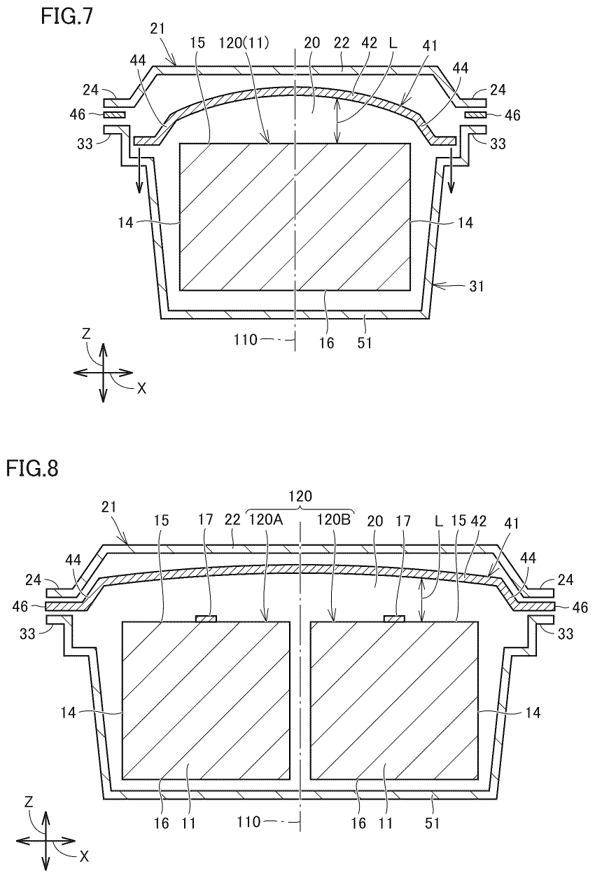

Referring to FIG. 7, in the present modification, plate member 41 and gasket 46 are provided separately. Plate member 41 is attached to case main body 31.

As illustrated in the modifications described above, the configuration of inclined portion 42 is not particularly limited as long as distance L between top surface 15 and inclined portion 42 in the Z axis direction is decreased in the direction away from gas-release valve 17 in the X axis direction. Further, the supporting structure of plate member 41 in space 20 is not particularly limited. As an example other than the above, there may be employed such a structure that plate member 41 is supported by end plate 91 or cover 21.

Further, in order to reinforce plate member 41, a rib or irregularity may be provided in inclined portion 42. Further, inclined portion 42 may have an inclined shape such that the distance between top surface 15 and inclined portion 42 in the Z axis direction is decreased in the direction toward the end portion of cell assembly 120 in the Y axis direction also in the cross section taken along the Y-Z axes plane. In this case, inclined portion 42 has a dome shape.

Summarizing the above-described structure of battery pack 100 according to the embodiment of the present invention, battery pack 100 according to the present embodiment includes: the plurality of battery cells 11; case main body 31 provided with opening 30; cover 21 that is attached to case main body 31 so as to close opening 30 and that forms, together with case main body 31, space 20 for accommodating the plurality of battery cells 11; plate member 41 disposed between each of the plurality of battery cells 11 and cover 21 in space 20, plate member 41 being composed of a metal or ceramic; and gasket 46 sandwiched by case main body 31 and cover 21, gasket 46 being composed of a metal or ceramic. Each of battery cells 11 has: exterior package 12 that includes a top surface 15 facing plate member 41 and that accommodates the electrode assembly and the electrolyte solution; and gas-release valve 17 that releases gas from inside of exterior package 12 to space 20 through top surface 15 when pressure in exterior package 12 becomes more than or equal to a predetermined value. The plurality of battery cells 11 are disposed in the frame to form cell assembly 120, the frame having a rectangular shape in which the Y axis direction serving as the second direction corresponds to the long-side direction of the frame and the X axis direction serving as the third direction orthogonal to the Y axis direction corresponds to the short-side direction of the frame when viewed in the Z axis direction serving as the first direction orthogonal to top surface 15. Plate member 41 has inclined portion 42. Inclined portion 42 is inclined such that distance L between top surface 15 and inclined portion 42 in the Z axis direction is decreased in the direction toward the end portion of cell assembly 120 in the X axis direction.

According to battery pack 100 thus configured in the first embodiment of the present invention, even when the high-pressure gas is jetted from battery cell 11 or the spontaneous ignition is caused by the jetting of the high-pressure gas, the leakage of the gas from space 20 and the damage of cover 21 can be more securely prevented.

### Second Embodiment

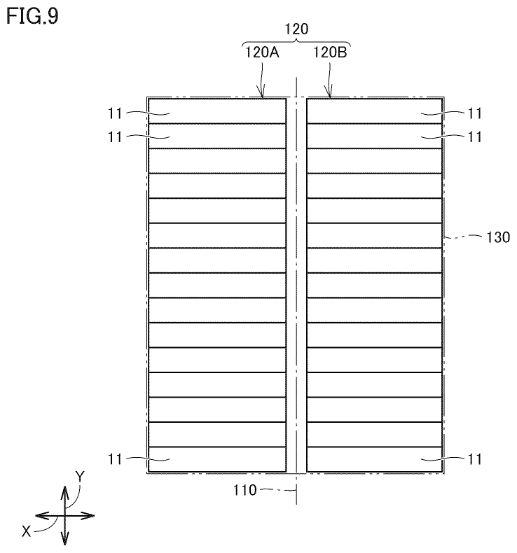

FIG. 8 is a cross sectional view showing a battery pack according to a second embodiment of the present invention. FIG. 8 corresponds to FIG. 4 in the first embodiment. FIG. 9 is a top view showing a cell assembly included in the battery pack in FIG. 8.

The battery pack according to the present embodiment has basically the same structure as battery pack 100 according to the first embodiment. Hereinafter, the same structure will not be described repeatedly.

Referring to FIGS. 8 and 9, in the present embodiment, battery cells 11 are stacked in two rows in the Y axis direction. The plurality of battery cells 11 are disposed in a frame 130 to form a cell assembly 120, frame 130 having a rectangular shape in which the Y axis direction corresponds to the long-side direction of frame 130 and the X axis direction corresponds to the short-side direction of frame 130 when viewed in the Z axis direction. Frame 130 is a line of minimum imaginary frame in which the plurality of battery cells 11 are disposed. The short side of frame 130 extends in the X axis direction, and the long side of frame 130 extends in the Y axis direction.

Cell assembly 120 is constituted of a first cell assembly 120A and a second cell assembly 120B. First cell assembly 120A is constituted of a plurality of battery cells 11 stacked in one row in the Y axis direction. Second cell assembly 120B is constituted of a plurality of battery cells 11 stacked in one row in the Y axis direction. First cell assembly 120A and second cell assembly 120B are arranged side by side at an interval in the X axis direction.

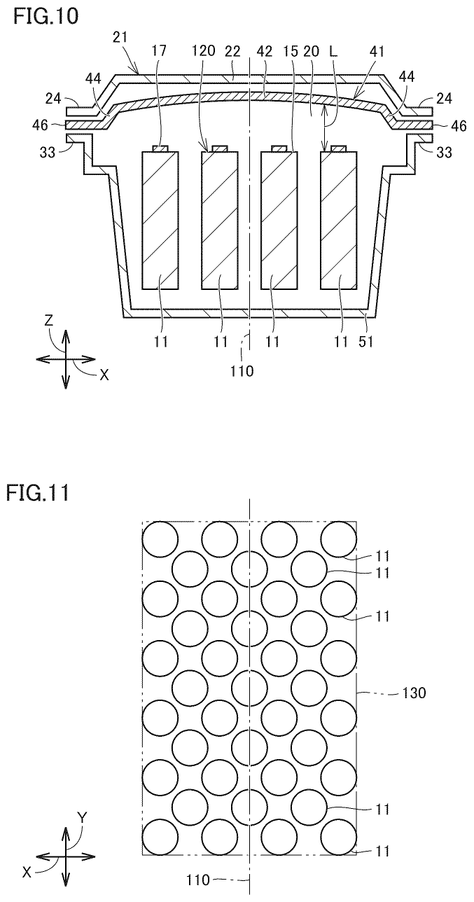

FIG. 10 is a cross sectional view showing a modification of the battery pack in FIG. 8. FIG. 11 is a top view showing a cell assembly included in the battery pack in FIG. 10.

Referring to FIGS. 10 and 11, in the present modification, each of battery cells 11 has a cylindrical shape. The plurality of battery cells 11 are arranged at intervals in the X-Y axes plane with each of battery cells 11 being in an upright posture in which the cylindrical axis of battery cell 11 extends in the Z axis direction. Gas-release valve 17 is provided on top surface 15 of battery cell 11. Gas-release valve 17 may be provided inside a sealing body included in top surface 15 of battery cell 11.

The plurality of battery cells 11 are disposed in a frame 130 to form a cell assembly 120, frame 130 having a rectangular shape in which the Y axis direction corresponds to the long-side direction of frame 130 and the X axis direction corresponds to the short-side direction of frame 130 when viewed in the Z axis direction.

In the configuration shown in FIGS. 8 to 11, inclined portion 42 is inclined such that distance L between top surface 15 and inclined portion 42 in the Z axis direction is decreased in the direction toward the end portion of cell assembly 120 in the X axis direction. In the present embodiment, the plurality of battery cells 11 may include a battery cell 11 having a gas-release valve 17 directly above which the topmost portion of inclined portion 42 is not located.

According to the battery pack thus configured in the second embodiment of the present invention, the same effects as those of battery pack 100 of the first embodiment can be exhibited.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A battery pack comprising:
a plurality of battery cells;
a case main body provided with an opening;
a cover that is attached to the case main body so as to close the opening and that forms, together with the case main body, a space for accommodating the plurality of battery cells;
a plate member disposed between each of the plurality of battery cells and the cover in the space, the plate member being composed of a metal or ceramic; and
a gasket sandwiched by the case main body and the cover, the gasket being composed of a metal or ceramic, wherein
each of the battery cells has
an exterior package that includes a top surface facing the plate member and that accommodates an electrode assembly and an electrolyte solution, and
a gas-release valve that releases gas from inside of the exterior package to the space through the top surface when pressure in the exterior package becomes more than or equal to a predetermined value,
the plurality of battery cells are disposed in a frame to form a cell assembly, the frame having a rectangular shape in which a second direction corresponds to a long-side direction of the frame and a third direction orthogonal to the second direction corresponds to a short-side direction of the frame when viewed in a first direction orthogonal to the top surface, and
the plate member has an inclined portion, the inclined portion being inclined such that a distance between the top surface and the inclined portion in the first direction is decreased in a direction toward an end portion of the cell assembly in the third direction.

2. The battery pack according to claim 1, wherein
the battery cell has a prismatic shape,
the plurality of battery cells are stacked in one row in the second direction, and
the distance between the top surface and the inclined portion in the first direction is decreased in a direction away from the gas-release valve in the third direction.

3. The battery pack according to claim 1, further comprising a duct that is provided to face the cell assembly in the third direction, that forms a gas flow path communicating with the space, and that discharges the gas from the space.

4. The battery pack according to claim 1, wherein the plate member and the gasket are integrally formed from a plate material composed of a metal or ceramic.
